(19) United States
(12) Patent Application Publication
(10) Pub. No.: US 2025/0144743 A1
(43) Pub. Date: May 8, 2025

(54) Welding Device

(71) Applicants: TE Connectivity Solutions GmbH, Schaffhausen (CH); Tyco Electronics (Shanghai) Co., Ltd., Shanghai (CN)

(72) Inventors: Xianghao (Jorge) Bao, Shanghai (CN); Jian Cao, Shanghai (CN); Dandan (Emily) Zhang, Shanghai (CN); Sun Kyu Pak, Middletown, PA (US); Roberto Francisco-Yi Lu, Middletown, PA (US); Mulang Song, Middletown, PA (US); Lvhai (Samuel) Hu, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 18/938,460

(22) Filed: Nov. 6, 2024

(30) Foreign Application Priority Data
Nov. 6, 2023 (CN) 202311468634.5

(51) Int. Cl. B23K 20/26; B23K 20/10; B23K 37/04; B65H 23/18

(52) U.S. Cl. CPC B23K 20/26; B23K 20/10; B23K 37/0435; B65H 23/1806; B65H 2701/37

(57) ABSTRACT

A welding device includes a thin film and an ultrasonic welding machine including an ultrasonic welding head welding a first component and a second component of a product together. The thin film is pressed against the product by the ultrasonic welding head and covers a welding area and a non-welding area of the product. The thin film absorbs a vibration energy located in the non-welding area to prevent the vibration energy from being concentrated in the welding area of the product.

### CROSS-REFERENCE TO RELATED APPLICATION

This application claims the benefit of the filing date under 35 U.S.C. § 119 (a)-(d) of Chinese Patent Application No. 202311468634.5, filed on Nov. 6, 2023.

### FIELD OF THE INVENTION

The present invention relates to a welding device, particularly to an ultrasonic welding device for welding a first component and a second component of a product together.

### BACKGROUND OF THE INVENTION

It is usually necessary to install a dust-proof end cap on a port of a connector housing. In order to prevent the end cap from detaching from the connector housing, it is sometimes necessary to use ultrasonic welding technology to weld the end cap to the connector housing. The welding area of the connector housing and end cap is usually an annular end face, while the cavity area inside the connector housing and end cap is a non-welding area.

During welding, the ultrasonic welding head covers both the welding and non-welding areas of the connector housing and end cap. This results in almost all of the vibration generated by the ultrasonic welding head being transmitted to the welding area of the connector housing and end cap, causing the welding area of the connector housing and end cap to be eroded and severely reducing the welding quality.

### SUMMARY OF THE INVENTION

A welding device includes a thin film and an ultrasonic welding machine including an ultrasonic welding head welding a first component and a second component of a product together. The thin film is pressed against the product by the ultrasonic welding head and covers a welding area and a non-welding area of the product. The thin film absorbs a vibration energy located in the non-welding area to prevent the vibration energy from being concentrated in the welding area of the product.

### BRIEF DESCRIPTION OF THE DRAWINGS

The invention will now be described by way of example with reference to the accompanying figures, of which:

FIG. 1 shows an illustrative plan view of a welding device according to an exemplary embodiment of the present invention;

FIG. 2 shows a schematic view of a welding device according to an exemplary embodiment of the present invention;

FIG. 3 shows a schematic view of the coverage area of an exemplary thin film, as well as the welding and non-welding areas of the welded product;

FIG. 4 shows an illustrative perspective view of a thin film conveying device of a welding device according to an exemplary embodiment of the present invention;

FIG. 5 shows an illustrative plan view of a thin film conveying device of a welding apparatus according to an exemplary embodiment of the present invention, wherein the conveyed thin film is shown;

FIG. 6 shows an illustrative perspective view of a clamping device of a welding device according to an exemplary embodiment of the present invention, in which the first and second components of the product are pre-assembled together; and

FIG. 7 shows an illustrative perspective view of the clamping device of a welding device according to an exemplary embodiment of the present invention, wherein the first component of the product has not yet been pre-assembled on the second component.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

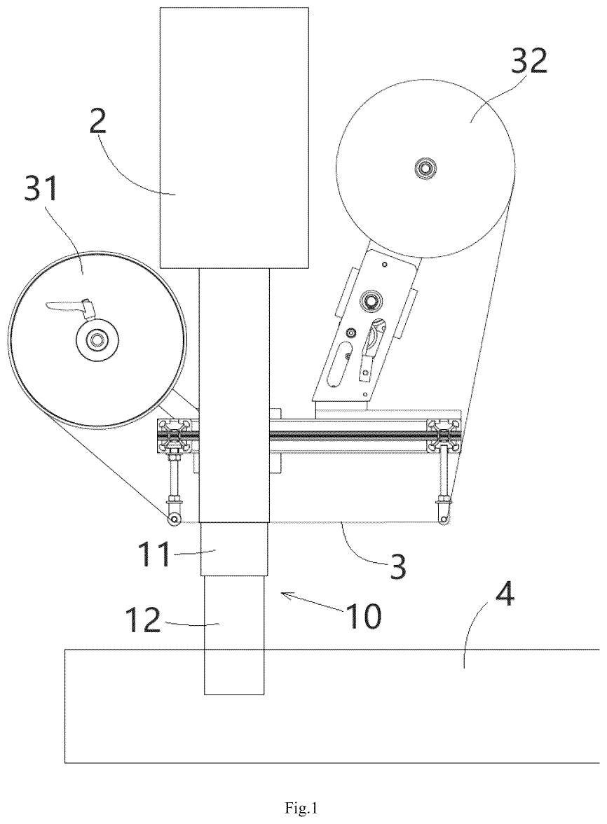

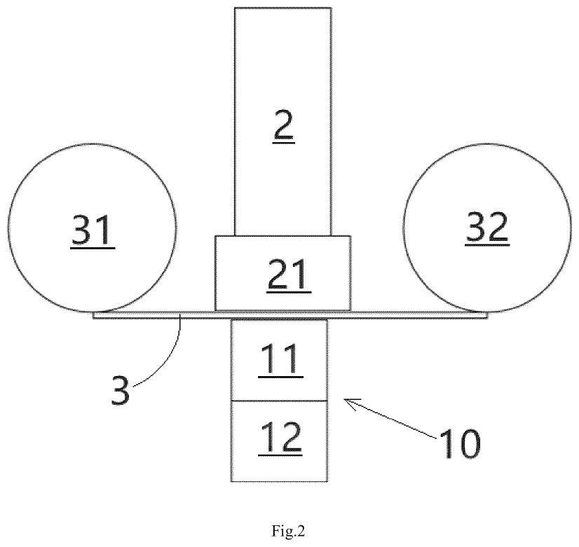

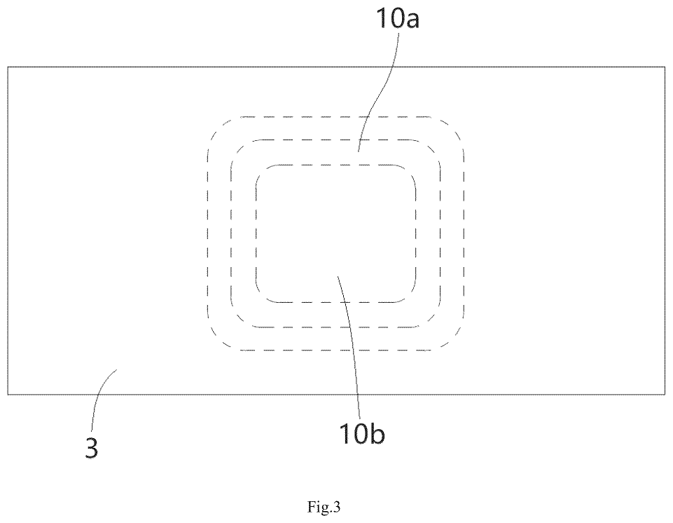

As shown in FIGS. 1 and 2, in an exemplary embodiment of the present invention, a welding device is disclosed. The welding device includes a thin film 3 and an ultrasonic welding machine 2. The ultrasonic welding machine 2 is used to weld a first component 11 and a second component 12 of product 10 together. The ultrasonic welding machine 2 includes an ultrasonic welding head 21. When welding the first and second components 11, 12, the thin film 3 is pressed against the product 10 by the ultrasonic welding head 21 and covers a welding area 10a and a non- welding area 10b of the product 10, shown in FIG. 3, to absorb the vibration energy located in the non-welding area 10b and prevent the vibration energy from being concentrated in the welding area 10a of the product 10.

In an embodiment, the thin film 3 can be a common insulating film, and the product 10 can be a plastic product, such as an injection molded product.

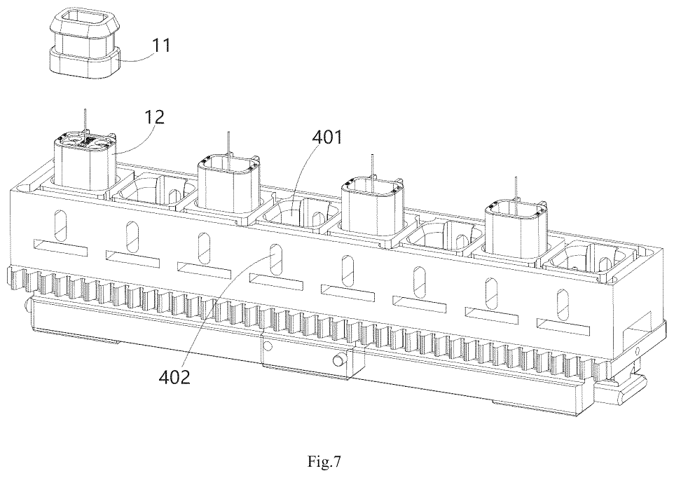

As shown in FIGS. 3, 6, and 7, in the illustrated embodiment, the welding area 10a of product 10 corresponds to the annular welding surface 101 of product 10, and the non-welding area 10b of product 10 corresponds to the hollow inner cavity 102 of product 10.

In the illustrated embodiment, the product 10 can be a connector housing assembly, the second component 12 is the connector housing, and the first component 11 is an end cap that is fitted onto one end of the connector housing.

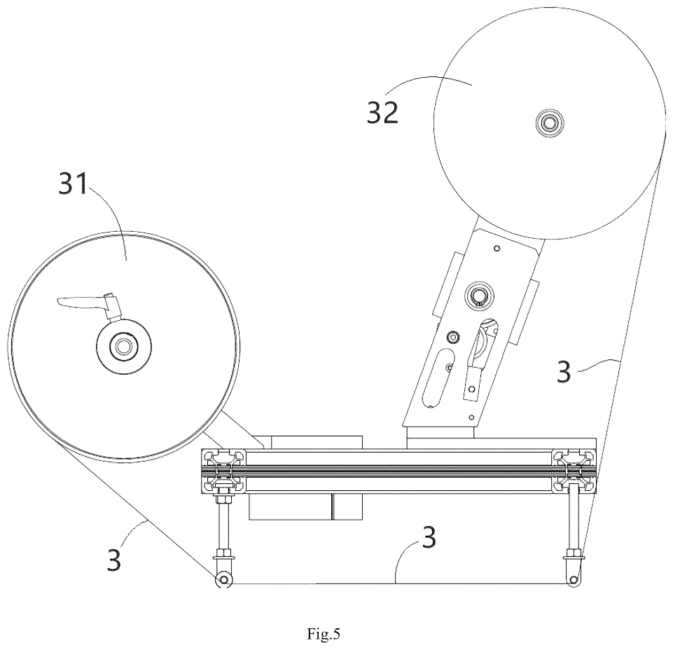

As shown in FIGS. 1, 2, 4, and 5, in the illustrated embodiment, the welding device further comprises a thin film conveying device 30 for conveying the thin film 3 onto the product 10. The thin film conveying device 30 includes a feeding reel 31, a recycling reel 32, and a tensioning device. The thin film 3 is wound around the feeding reel 31. The recycling reel 32 is used to recycle the used thin film 3. The tensioning device is set between the feeding reel 31 and the recycling reel 32. The tensioning device is used to tighten a section of thin film 3 into a flat state, so that the tensioned section of thin film 3 is suitable for being attached to the end face 10c of the product 10.

During the welding of the first and second components 11, 12, the tensioned section of thin film 3 is pressed against the end face 10c of the product 10 by the ultrasonic welding head 21 and covers the welding area 10a and non-welding area 10b of the product 10.

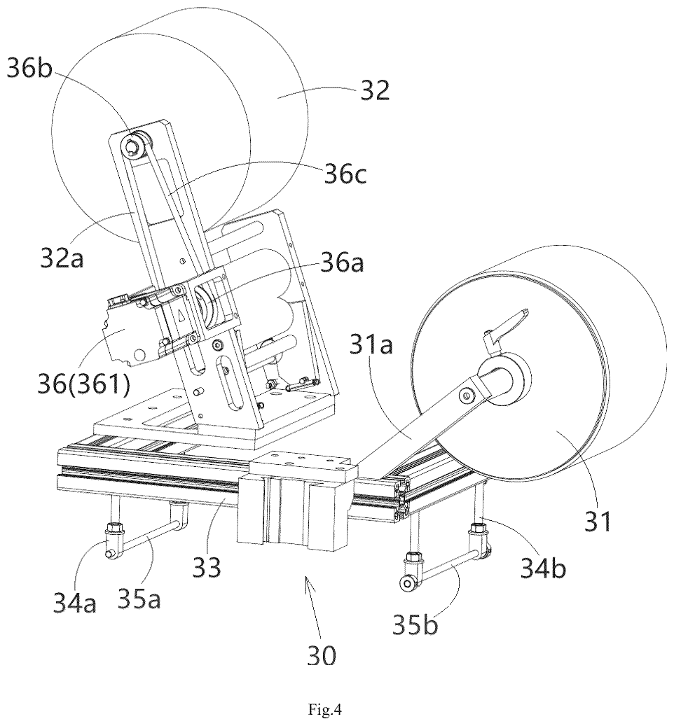

As shown in FIG. 4, in the illustrated embodiment, the tensioning device includes a pair of first brackets 34a, a first tensioning roller 35a, a pair of second brackets 34b, and a second tensioning roller 35b. The two ends of the first tension roller 35a are respectively rotatably mounted on the pair of first brackets 34a. The pair of second brackets 34b are spaced from the pair of first brackets 34a. The two ends of the second tension roller 35b are respectively rotatably mounted on the pair of second brackets 34b. A section of thin film 3 is tensioned between the first tensioning roller 35a and the second tensioning roller 35b.

As shown in FIG. 4, in the illustrated embodiment, the thin film conveying device 30 further comprises a first mounting frame 31a, a second mounting frame 32a, and a driving device 36. The feeding reel 31 is rotatably mounted on the first mounting bracket 31a. The recycling reel 32 is rotatably mounted on the second mounting bracket 32a. The driving device 36 is installed on the second mounting bracket 32a to drive the recycling reel 32 to rotate.

As shown in FIG. 4, in the illustrated embodiment, the driving device 36 includes a motor 361, a first pulley 36a, a second pulley 36b, and a transmission belt 36c. The motor 361 is fixed to the second mounting bracket 32a. The first pulley 36a is connected to the output shaft of the motor 361. The second pulley 36b is connected to the rotating shaft of the recycling reel 32. The drive belt 36c is connected between the first pulley 36a and the second pulley 36b.

As shown in FIG. 4, in the illustrated embodiment, the thin film conveying device 30 further comprises a frame 33, which is used to fix the first mounting bracket 31a, the second mounting bracket 32a, the first bracket 34a, and the second bracket 34b. The first mounting bracket 31a and the second mounting bracket 32a are located above the frame 33, and the first bracket 34a and the second bracket 34b are located below the frame 33.

As shown in FIGS. 1, 6, and 7, in the illustrated embodiment, the welding device further comprises a clamping device for clamping and fixing the product 10. The clamping device comprises a positioning block 4 and a pair of clamping cylinders. A positioning slot 401 suitable for positioning the product 10 and a pair of insertion holes 402 communicated with the positioning slot 401 are formed in the positioning block 4. A pair of clamping cylinders are respectively set on both sides of the positioning block 4. The telescopic rods of the pair of clamping cylinders respectively extend into the pair of insertion holes 402, clamping the product 10 inserted into the positioning slot 401 from both sides. In the illustrated embodiment, a row of positioning slots 401 are formed on the positioning block 4 for simultaneously positioning multiple products 10.

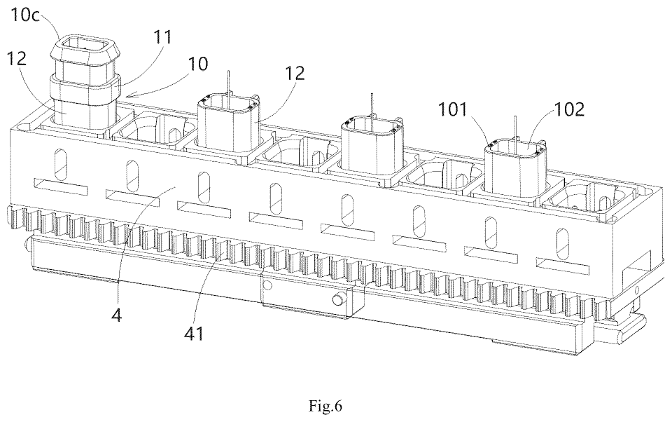

As shown in FIG. 6, in the illustrated embodiment, the welding device further comprises a moving device for moving the positioning block 4 in a predetermined direction to sequentially move multiple products 10 positioned in the positioning block 4 to the welding position aligned with the ultrasonic welding head 21. In the illustrated embodiment, the moving device includes a rack 41, a gear, and a servo motor. The rack 41 is fixed to the positioning block 4. The gear is meshed with the rack 41. The servo motor is connected to the gear and used to drive the gear to rotate. When the gear is rotated, the rack 41 drives the positioning block 4 to move in the predetermined direction.

In the aforementioned exemplary embodiments according to the present invention, the thin film 3 covers the welding 10a and non-welding 10b areas of the product 10, so that the vibration energy located in the non-welding area 10b is absorbed by the thin film 3 and not transmitted to the welding area 10a of the product 10, thereby effectively preventing the welding area 10a of the product 10 from being eroded and improving the welding quality of the product 10.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A welding device, comprising:
a thin film; and
an ultrasonic welding machine including an ultrasonic welding head welding a first component and a second component of a product together, the thin film is pressed against the product by the ultrasonic welding head and covers a welding area and a non-welding area of the product, the thin film absorbs a vibration energy located in the non-welding area to prevent the vibration energy from being concentrated in the welding area of the product.

2. The welding device of claim 1, wherein the welding area is an annular welding surface of the product.

3. The welding device of claim 2, wherein the non-welding area is a hollow inner cavity of the product.

4. The welding device of claim 1, wherein the product is a connector housing assembly, the second component is a connector housing, and the first component is an end cap that is fitted onto the connector housing.

5. The welding device of claim 1, further comprising a thin film conveying device transporting the thin film onto the product.

6. The welding device of claim 5, wherein thin film conveying device includes a feeding reel on which the thin film is wound, a recycling reel used for recycling the thin film, and a tensioning device installed between the feeding reel and the recycling reel.

7. The welding device of claim 6, wherein the tensioning device tightens a tensioned section of thin film into a flat state, the tensioned section of the thin film is attached to an end face of the product.

8. The welding device of claim 7, wherein the tensioned section of the thin film is pressed against the end face of the product by the ultrasonic welding head and covers the welding area and non-welding area of the product.

9. The welding device of claim 8, wherein the tensioning device includes a pair of first brackets, a first tension roller having a pair of ends respectively rotatably mounted on the pair of first brackets, a pair of second brackets spaced from the pair of first brackets, and a second tension roller having a pair of ends respectively rotatably mounted on the pair of second brackets, the tensioned section of the thin film is tensioned between the first tension roller and the second tension roller.

10. The welding device of claim 9, wherein the thin film conveying device includes a first mounting bracket on which the feeding reel is rotatably mounted, a second mounting bracket on which the recycling reel is rotatably mounted, and a driving device installed on the second mounting bracket for driving the recycling reel to rotate.

11. The welding device of claim 10, wherein the driving device includes a motor fixed to the second mounting bracket, a first pulley connected to an output shaft of the motor, a second pulley connected to a rotating shaft of the recycling reel, and a transmission belt connected between the first pulley and the second pulley.

12. The welding device of claim 10, wherein the thin film conveying device includes a frame fixing the first mounting bracket, the second mounting bracket, the first brackets, and the second brackets.

13. The welding device of claim 12, wherein the first mounting bracket and the second mounting bracket are located above the frame, and the first brackets and the second brackets are located below the frame.

14. The welding device of claim 13, further comprising a clamping device clamping and fixing the product.

15. The welding device of claim 14, wherein the clamping device includes a positioning block having a positioning slot positioning the product and a pair of insertion holes communicated with the positioning slot.

16. The welding device of claim 15, wherein the clamping device includes a pair of clamping cylinders respectively set on a pair of sides of the positioning block, a pair of telescopic rods of the pair of clamping cylinders respectively extend into the pair of insertion holes, clamping the product inserted into the positioning slot.

17. The welding device of claim 15, wherein a row of positioning slots are formed on the positioning block for simultaneously positioning a plurality of products.

18. The welding device of claim 17, further comprising a moving device moving the positioning block in a predetermined direction to sequentially move the plurality of products positioned in the positioning block to a welding position aligned with the ultrasonic welding head.

19. The welding device of claim 18, wherein the moving device includes a rack fixed to the positioning block, a gear meshed with the rack, and a servo motor connected to the gear for driving the gear to rotate.

20. The welding device of claim 19, wherein, when the gear rotates, the rack drives the positioning block to move in the predetermined direction.
